(19) United States
(12) Patent Application Publication
(10) Pub. No.: US 2006/0210102 A1
(43) Pub. Date: Sep. 21, 2006

(54) Local telemetry device and method

(76) Inventors: Maxim Zalalutdinov, Silver Springs, MD (US); Keith Aubin, Freeville, NY (US); Robert B. Reichenbach, Ithaca, NY (US); Jeevak M. Parpia, Ithaca, NY (US); Harold G. Craighead, Ithaca, NY (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/358,675

(22) Filed: Feb. 20, 2006

Related U.S. Application Data
(63) Continuation of application No. PCT/US04/27163, filed on Aug. 20, 2004.
(60) Provisional application No. 60/496,450, filed on Aug. 20, 2003.

(51) Int. Cl. H04R 25/00

(52) U.S. Cl. 381/315

(57) ABSTRACT

Position tracking of a receiving device within a gas or fluidic environment (for example a human body), is performed by measuring acoustic wave propagation parameters to provide real time, high precision telemetry. Multiple synchronized acoustic sources at different known locations transmit signals that are received by a receiver on the device to be located. The coordinates of the receiver can be determined by measuring a difference in the amplitude (coarse positioning) or phase (precise positioning) of the acoustic waves coming from different sources using triangulation calculations.

### RELATED APPLICATIONS

This application is a Continuation Under 35 U.S.C. § 1.111(a) of International Application No. PCT/US2004/027163, filed Aug. 20, 2004 and published in English as WO 2005/019860 on Mar. 3, 2005, which claims priority to U.S. Provisional Application Ser. No. 60/496,450, filed Aug. 20, 2003, which applications are incorporated herein by reference.

### GOVERNMENT FUNDING

The invention described herein was made with U.S. Government support under Grant Number DMR0079992 awarded by the National Science Foundation. The United States Government has certain rights in the invention.

### BACKGROUND

Certain intestinal disorders are investigated with small devices the size of a pill, that transmit pressure readings as they progress through intestines. A receiver is located near a person swallowing the pill to receive the transmitted pressure readings. A general idea of the pressures generated as the pill progresses is obtained, but information as to the relative position of the pill in the intestines is not known. Electromagnetic waves have been used to attempt to track the pill more precisely, but the conductivity of the body can interfere with such waves. At best, a one foot resolution may be obtained in this manner. There is a need for higher precision.

### SUMMARY

A device includes a microphone for receiving multiple acoustic signals transmitted by external transmitters. A transducer coupled to the microphone converts received acoustical energy into an electrical signal. A transmitter is coupled to the transducer for broadcasting signals representative of a phase difference between the multiple acoustic signals received by the microphone, thereby providing information from which the position of the device may be determined.

In one embodiment, position tracking of a receiving device within a gas or fluidic environment (for example a human body), is performed by measuring acoustic wave propagation parameters to provide real time, high precision telemetry. Multiple synchronized acoustic sources at different known locations transmit signals that are received by a receiver on the device to be located. The coordinates of the receiver can be determined by measuring a difference in the amplitude (coarse positioning) or phase (precise positioning) of the acoustic waves coming from different sources using triangulation calculations.

In one embodiment, all the sources are externally synchronized and only the difference in the wave propagation delay time at the receiver location is to be measured (by comparing, for example, the phase of binary signal sequence modulating the carrier acoustic wave). Such a differential scheme eliminates the necessity to have a precise clock located at the receiver and greatly simplifies signal processing to be performed at the receiver. That leads to substantial miniaturization of the device and reduction of the power consumption, essential for numerous medical applications (e.g. implanted medical device IMD). Intermittent or periodic transmission rates can further reduce power consumption.

### BRIEF DESCRIPTION OF THE DRAWINGS

FIG. 1 is a block diagram of an acoustic telemetry system according to an example embodiment.

FIG. 2 is a block diagram of an alternative acoustic telemetry system according to an example embodiment.

FIG. 3 is a block diagram of a receiver for the acoustic telemetry system of FIG. 1.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

Position tracking of a receiving device within a gas or fluidic environment (for example a human body), is performed by measuring acoustic wave propagation parameters to provide real time, high precision telemetry. Multiple synchronized acoustic sources at different known locations transmit signals that are received by a receiver on the device to be located. The coordinates of the receiver can be determined by measuring a difference in the amplitude (coarse positioning) or phase (precise positioning) of the acoustic waves coming from different sources using triangulation calculations.

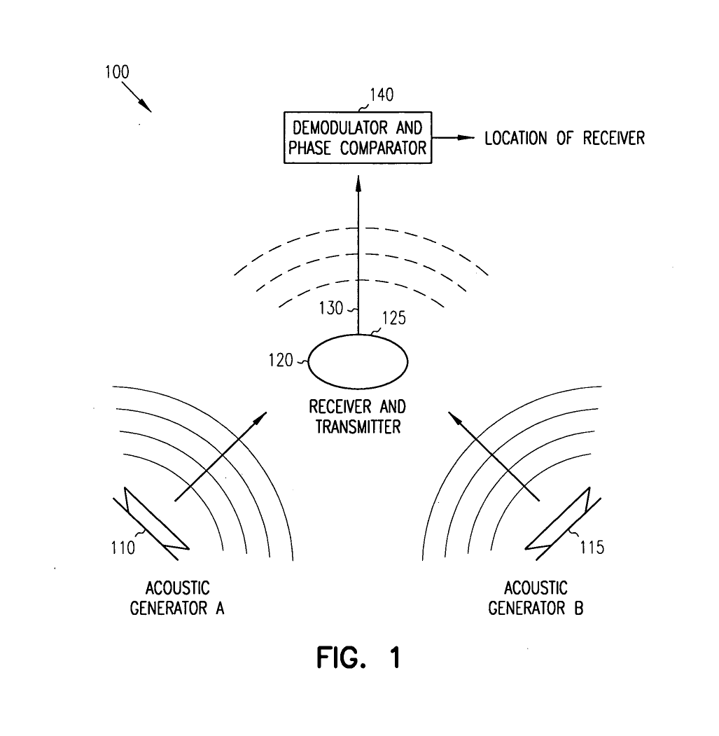

In one embodiment as shown generally at 100 in FIG. 1, a pair of point-like acoustic signal generators 110 and 115 are located at different known external positions. The signal generators 110 and 115 may be located on a harness that may be worn on a human or animal body such that they are at desired fixed locations. The generators 110 and 115 transmit at close but different carrier frequencies (ω₁ and ω₂). In one embodiment, the frequencies are of a wavelength in the short acoustic range, similar to frequencies used for ultrasound medical imaging applications. Identical modulation with a wide base-band frequency range ωₘ(t) may be applied to both of the signals
I₁(t)=₁⁰ sin ((ω₁+ωₘ(t))t) I₂(t)=I₂⁰ sin ((ω₂+ωₘ(t))t)

A microphone 120 is located on a device such as a receiver 125 located inside a medium, such as a body, is tuned to receive the modulated carrier signals. These signals will be phase shifted (φ₁, φ₂) relative to each other and attenuated due to a difference in distance between the receiver and generators. Within the medium, propagation velocity differences in different materials, such as organs and tissues, are negligible (and in some cases can be accounted for) leading to minimal parasitic phase delay of the acoustic signal.
R₁(t)=A₁I₁⁰ sin((ω₁+ωₘ(t))t+φ₁) R₂ (t)=A₂I₂⁰ sin((ω₂+ωₘ(t))t+φ₂)

Where A₁ and A₂ are attenuation of the acoustic waves, determined by the travel distance and properties of the media. The microphone 120 or transducer on the receiver 125 converts received acoustical energy into an electrical signal, and after amplification, rebroadcasts the signals using, for example, an RF transmitter 130 or other type of communication channel.

$${I}_{radio} ( t ) = {I}_{radio}^{0} [ \begin{matrix}{R}_{1} sin ( ( {ω}_{1} + {ω}_{m} ( t ) ) t + {ϕ}_{1} ) + \\ {R}_{2} sin ( ( {ω}_{2} + {ω}_{m} ( t ) ) t + {ϕ}_{2} )\end{matrix} ]$$

External signal processing 140 or triangulator, such as a demodulator and phase comparator, is used to demodulate the rebroadcast signals in order to determine the phase difference φ₂−φ₁ and discern the propagation distance difference between the two signal generators 110, 115 and the internal receiver 125. The demodulator and phase comparator may be implemented by software or firmware, or a combination of the two, and may be implemented on an ASIC or other hardware device.

In one embodiment a programmable delay may be introduced in one of the acoustic generators 110, 115 (according to measured φ₂−φ₁) to compensate the difference in propagation time and to provide exact in-phase arrival of the signals to the receiver. Delay time (equal to difference in propagation time) is used to calculate the difference in distance between the receiver and each of the sources.

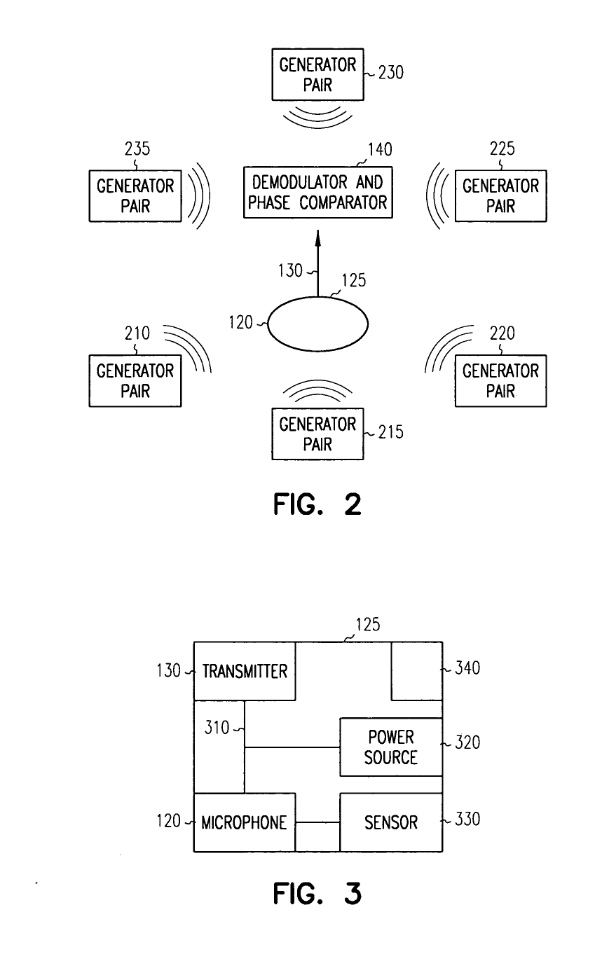

In order to determine three dimensional resolution as well as velocity and acceleration measurements, several pairs of acoustic signal generators 210, 215, 220, 225, 230 and 235 as seen in FIG. 2, located in various positions can sequentially broadcast in the aforementioned process. A sequencer in one of the signal generators or in a separate controller, controls the multiple pairs of acoustic transmitters to transmit in sequence. The positions of the generators are precisely known, so the receiver's position can be determined through triangulation.

A block diagram of an example receiver 125 is shown in FIG. 3. The receiver may be sized such that it is swallowable by a human or animal subject. The example receiver comprises microphone 120 and transmitter 130. Microphone 120 converts the received acoustic signals into electrical signals and provides them to transmitter 130 on a conductive line 310. Line 310 may contain circuitry, such as amplifiers or other circuitry to properly condition the microphone signal for use by the transmitter. Transmitter 130 in one embodiment is a RF transmitter, but may utilize other frequencies if desired in a manner to communication the signals outside the body to the external signal processing 140. A power source 320, such as a battery provides power to components within the receiver 125. In one embodiment, the receiver 125 is formed of biocompatible materials, such as epoxy. It may be of a size suitable for swallowing by a human, such as pill sized. Portions of the receiver 125 may be made of piezoelectric material, which can function as a microphone.

The receiver 125 in one embodiment comprises a sensor 330, such as a pressure sensor, temperature sensor, acidity sensor or other type of sensor. The sensor is also coupled to the transmitter, which transmits signals representative of a sensed parameter, such as pressure, temperature or pH. In one embodiment, line 310 comprises an upconverter for converting signals into a MHz range signal for transmission. Line 310 may also contain circuitry that provides for intermittent transmission, such as at one minute intervals or other desired interval to save battery life. Line 310 may also comprise a receiver for receiving external commands. For instance, such commands may initiate transmission of information, may change the interval of transmission, or may be used to stop transmission. Other commands may be implemented as desired.

Line 310, when comprising circuitry, may contain computer-readable instructions stored on a computer-readable medium that are executable by a processing unit of the computer or other instruction executing circuitry.

In yet a further embodiment, a portion of the pill may comprise a compartment of desired volume 340. The compartment may contain a therapeutic substance such as a medication or other type of substance, such as a diagnostic marker or other material that is releasable by command, or at a predetermined time by actuation of a latch, also represented at 340.

The Abstract is provided to comply with 37 C.F.R. §1.72 (b) to allow the reader to quickly ascertain the nature and gist of the technical disclosure. The Abstract is submitted with the understanding that it will not be used to interpret or limit the scope or meaning of the claims.

### Conclusion

Position tracking of a receiving device within a gas or fluidic environment (for example a human body), is performed by measuring acoustic wave propagation parameters to provide real time, high precision telemetry. Multiple synchronized acoustic sources at different known locations transmit signals that are received by a receiver on the device to be located. The coordinates of the receiver can be determined by measuring a difference in the amplitude (coarse positioning) or phase (precise positioning) of the acoustic waves coming from different sources using triangulation calculations.

All the sources are externally synchronized and only the difference in the wave propagation delay time at the receiver location is to be measured (by comparing, for example, the phase of binary signal sequence modulating the carrier acoustic wave). Such a differential scheme eliminates the necessity to have a precise clock located at the receiver and greatly simplifies signal processing to be performed at the receiver. That leads to substantial miniaturization of the device and reduction of the power consumption, essential for numerous medical applications (e.g. implanted medical device IMD).

This differential principle of telemetry can be expanded if different kind of waves, with different propagation speeds are employed. For example, supplementary to the acoustic waves, an electromagnetic radio frequency (E&M RF) communication channel can be established between the sources and the device. The distance between each source and the device can be measured by detecting the difference in propagation time between the acoustic and E&M waves.

Acoustic sources/receiver can operate in far-field mode, which greatly expands the area and simplifies signal analysis. For many applications the size of the hydrophone (determined by the acoustic wavelength) can be in the millimeter or even sub-millimeter range.

1. A device comprising:
a microphone for receiving multiple acoustic signals;
a transducer coupled to the microphone for converting received acoustical energy into an electrical signal; and
a transmitter coupled to the transducer for broadcasting signals representative of a phase difference between the multiple acoustic signals received by the microphone.

2. The device of claim 1 and further comprising a sensor coupled to the transmitter.

3. The device of claim 2 wherein the sensor comprises a pressure sensor, a temperature sensor or an acidity sensor.

4. The device of claim 1 and further comprising an up converter that converts the electrical signal into a megahertz range signal for transmission.

5. The device of claim 1 and further comprising a container for holding a substance that can be controllably released.

6. The device of claim 1 and further comprising a receiver for receiving commands.

7. The device of claim 1 wherein the received acoustical signals are provided on close but different carrier frequencies (ω₁ and ω₂).

8. The device of claim 7 wherein the frequencies are in the short acoustic range.

9. The device of claim 8 wherein identical modulation with a wide base-band frequency range ωₘ(t) is applied to both of the acoustic signals.

10. The device of claim 1 wherein the received acoustic signals are phase shifted (φ₁, φ₂) relative to each other and attenuated due to a difference in distance between the microphone and known points at which they were originally transmitted.

11. A system for locating a device, the system comprising:
a first acoustic transmitter transmitting a first acoustic signal within reception of the device on a first carrier frequency;
a second acoustic transmitter spaced apart from the first acoustic transmitter, the second acoustic transmitter transmitting a second acoustic signal within reception of the device on a second carrier frequency close to the first frequency;
wherein the first and second acoustic signals are modulated with a same wide base-band frequency range; and
a triangulator that receives signals from the device representative of a phase difference between the first and second acoustic signals received at the device.

12. The system of claim 11 wherein the locations of the acoustic transmitters is known to the triangulator.

13. The system of claim 1 1 wherein the triangulator determines a propagation distance difference between the two acoustic transmitters and the device.

14. The system of claim 11 wherein the triangulator comprises a demodulator and phase comparator used to demodulate the received signals in order to determine a phase difference φ₂−φ₁ and discern a propagation distance difference between the two acoustic transmitters and the device.

15. The system of claim 11 wherein a programmable delay is provided in one of the acoustic transmitters to compensate for a difference in propagation time.

16. The method of claim 15 wherein the programmable delay also provides for exact in-phase arrival of the signals at the device.

17. A system for locating a device, the system comprising:
multiple pairs of first and second acoustic transmitters transmitting acoustic signals differing slightly in frequency, and identically modulated with a same wide base-band frequency range;
a triangulator that receives a signal from the device representative of a phase difference between the first and second acoustic signals received at the device; and
a sequencer that controls the multiple pairs of first and second acoustic transmitters to transmit in sequence.

18. The system of claim 17 wherein the positions of the multiple pairs of first and second acoustic transmitters are precisely known.

19. A system comprising
a device having:
a microphone for receiving multiple acoustic signals;
transducer coupled to the microphone for converting received acoustical energy into an electrical signal;
a transmitter coupled to the transducer for broadcasting signals representative of a phase difference between acoustic signals received by the microphone;
a first acoustic transmitter transmitting a first acoustic signal within reception of the device on a first carrier frequency;
a second acoustic transmitter spaced apart from the first acoustic transmitter, the second acoustic transmitter transmitting a second acoustic signal within reception of the device on a second carrier frequency close to the first frequency;
wherein the first and second acoustic signals are modulated with a same wide base-band frequency range; and
a triangulator that receives the signals from the device representative of a phase difference between the first and second acoustic signals received at the device.

20. A method comprising:
receiving acoustic signals from multiple acoustic transmitters;
converting the received acoustic signals into electrical signals; and
transmitting an RF signal representative of the electrical signals such that the RF signals facilitate triangulation of a point where the acoustic signals are received.

21. The method of claim 20 and further comprising receiving commands.

22. The method of claim 21 wherein a selected command is executed to control the transmission of the RF signal.

23. The method of claim 21 wherein a selected command is executed to control release of a substance.

24. The method of claim 20 and further comprising performing triangulation based on the transmitted RF signal.

25. The method of claim 20 and further comprising sensing a parameter.

26. The method of claim 25 wherein the transmitted RF signal includes information about the sensed parameter.
